(19) United States
(12) Patent Application Publication
(10) Pub. No.: US 2008/0092678 A1
(43) Pub. Date: Apr. 24, 2008

(54) Dust-Proof Structure for a Ball Screw

(76) Inventors: Chi-Meng Liao, Taichung (TW); Chia-Min Liu, Taichung (TW)

Correspondence Address: Dr. BANGER SHIA, 102 Lindencrest Ct., Sugar Land, TX, 77479-5201, US

(21) Appl. No.: 11/466,181

(22) Filed: Aug. 22, 2006

(51) Int. Cl. F16H 25/24; F16C 29/08

(52) U.S. Cl. 74/89.4; 15/256.5

(57) ABSTRACT

A dust-proof structure for a ball screw comprises: a wiper, a wiping piece and a fastening device. The wiper is a C-shaped structure defined with a gap for accommodation of a wiping piece and is annually mounted on a surface of a screw shaft. The wiper is formed at either side of the gap with a bevel surface, and the wiping piece is also formed at both sides thereof with a bevel surface for mating with the bevel surface of the gap, so that the wiper and the wiping piece are maintained into contact via the bevel surfaces. The fastening device enables the C-shaped wiper to be deformed in radial direction, making the wiping piece abut against the surface of the screw shaft. By such arrangements, an interacting force between the bevel surfaces of the wiping piece and the wiper pushes the wiping piece toward the surface of the screw shaft, thus effectively preventing dust.

### BACKGROUND OF THE INVENTION

1. Field of the Invention

The present invention relates to a dust-proof structure for a ball screw, and more particularly to a low-friction wiper having a function of dust-proof.

2. Description of the Prior Art

Ball screw is currently used more and more widely in modern industries. In addition to its high precision transmission performance, the ball screw also has many other advantages, such as low friction loss, high ratio of energy conversion, low noise, high rigidity and wear-resistance. Therefore, it is self-evident that the ball screw is very important to various industrial mechanisms.

A conventional ball screw commonly seen on the market is usually provided with a wiper that is to be inserted and fixed in either end of a nut of the screw shaft by screws. The wiper uses its flange to prevent invasion of foreign material and maintain its lubricity. To compensate for a manufacturing error, there have to be a clearance, approximately 0.25 mm in length, between the flange of the conventional wiper and the helical groove of the screw shaft. However, manufacturing errors will increase the clearance. According to the well-known knowledge in the art, ball screw will be damaged when the foreign material is bigger than 0.17 mm. Thus, the conventional clearance (approximately 0.25 mm) will have the problems of invasion of foreign bodies and hence becoming less lubricant.

If we want to have a better wiping effect, the clearance cannot be reserved between the flange of the conventional wiper and the helical groove of the screw shaft. However, such a deign comes with a disadvantage that the flange of the wiper will be pressed too tightly against the helical groove of the screw shaft, which will considerably increase the friction force, and substantially decrease mechanical efficiency, thus resulting in a great number of foreign material accumulated between the wiper and the helical groove, and causing many problems.

A ball screw disclosed by U.S. Pat. No. 6,571,653 B1 is shown in FIG. 1. The wiper 10 also uses a flange 30 to prevent invasion of foreign bodies and loss of lubricant. And a spring coil is arranged at the end of the flange 30 to increase the radial force thereat, and a plurality of grooves having a closed end is formed in the flange 30 for the purpose of discharging machining bits. However, the design of the grooves 20 having one end closed will enable the foreign bodies to quickly accumulate and fill up the grooves 20 (in the feeding direction) during rotation, and the foreign bodies will be accumulated on the screw shaft forever. As a result, the mechanical efficiency of the ball screw will be largely reduced, and the spring will also become loose and fatigued easily after abrasion, resulting in an unstable stopping effect.

Another conventional type product is shown in FIG. 2, in which, a wiper 40 is positioned in the nut by an elastic ring 50. An abutting portion 60 is formed on the outer periphery of the wiper 40. Although this wiper 40 doesn't have the problem of the excessively tight contact caused friction and the problem of the reserved clearance caused by the manufacturing error, it still can't completely prevent the invasion of foreign material. After a long period time, foreign material will be accumulated between the nut and the screw shaft, causing a great number of lubricant loss and an unstable operation.

It is clear from the abovementioned products the clearance in conventional wipers is always a problem that manufacturers want to solve. During its use, clearance must be adjusted, cleaned and maintained regularly; otherwise, a clearance, either too big or too small, can severely affect the operation of a ball screw.

To solve the aforementioned problems, the inventor of this invention, based on his experiences and skills in the linear transmission field, developed a clearance-adjustable wiper for a ball screw, which has a simple structure to reduce the wiping resistance, and it can also prevent invasion of foreign material and remains lubricant.

### SUMMARY OF THE INVENTION

The primary objective of the present invention is to provide a low-friction wiper having a function of dust-proof.

To achieve the abovementioned objective, a dust-proof structure for a ball screw in accordance with the present invention comprises: a wiper, a wiping piece and a fastening device. The wiper is a C-shaped structure defined with a gap for accommodation of a wiping piece and is annually mounted on a surface of a screw shaft, the wiper is formed at either side of the gap with a bevel surface, the wiping piece is also formed at both sides thereof with a bevel surface for mating with the bevel surface of the gap, so that the wiper and the wiping piece are maintained into contact via the bevel surfaces; and

the fastening device enables the C-shaped wiper to be deformed in radial direction, making the wiping piece abut against the surface of the screw shaft;

By such arrangements, an interacting force between the bevel surfaces of the wiping piece and the wiper pushes the wiping piece toward the surface of the screw shaft, thus effectively preventing dust.

Since the dust-proof structure uses the bevel surfaces to contact the wiper, when the external force to be applied is Fc, the resultant pushing force of the wiping piece 2 toward the screw shaft is only Fc*sin a. Furthermore, when the angle a is no greater than 10°, the resultant pushing force of the wiping piece 2 toward the screw shaft is only approximately 0.15 Fc. Therefore, the wiping piece 2 will abut against the surface of the screw shaft with a very light force, so that the degree to which the wiping piece 2 abuts against the surface of the screw shaft is controllable. Therefore, it not only has the dust proof effect, but also can prevent the occurrence of the excessively great friction.

### BRIEF DESCRIPTION OF THE DRAWINGS

FIG. 1 is a cross sectional view of a conventional dust-proof structure for a ball screw disclosed by U.S. Pat. No. 6,571,653 B1;

FIG. 2 is a cross sectional view of a conventional dust-proof structure for a ball screw disclosed by U.S. Pat. No. 6,178,839 B1;

FIG. 3 is a plan view of a dust-proof structure for a ball screw in accordance with the present invention;

FIG. 4 is an illustrative view of showing the force analysis of the dust-proof structure for a ball screw in accordance with the present invention;

FIG. 5 is an exploded view of a dust-proof structure for a ball screw in accordance with a first embodiment of the present invention;

FIG. 6 is an illustrative view of a dust-proof structure for a ball screw in accordance with a second embodiment of the present invention;

FIG. 7 is an illustrative view of a dust-proof structure for a ball screw in accordance with a third embodiment of the present invention; and

FIG. 8 is an illustrative view of a dust-proof structure for a ball screw in accordance with a fourth embodiment of the present invention.

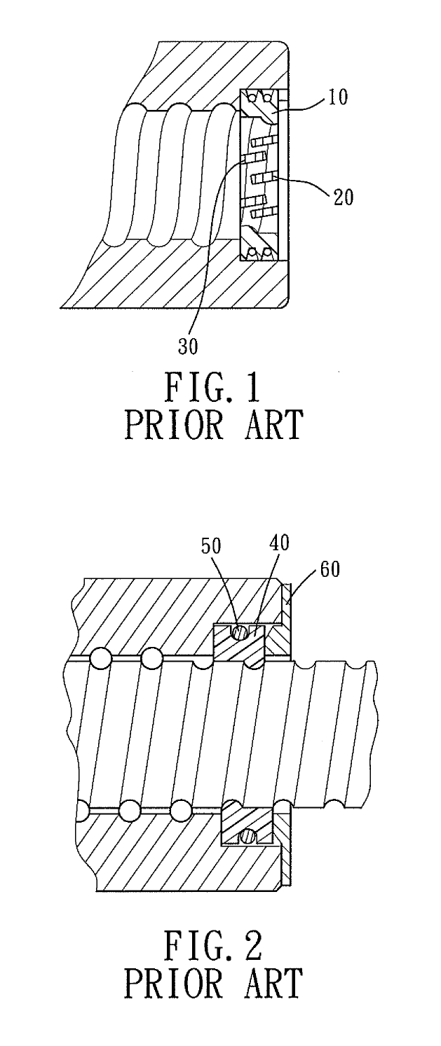

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

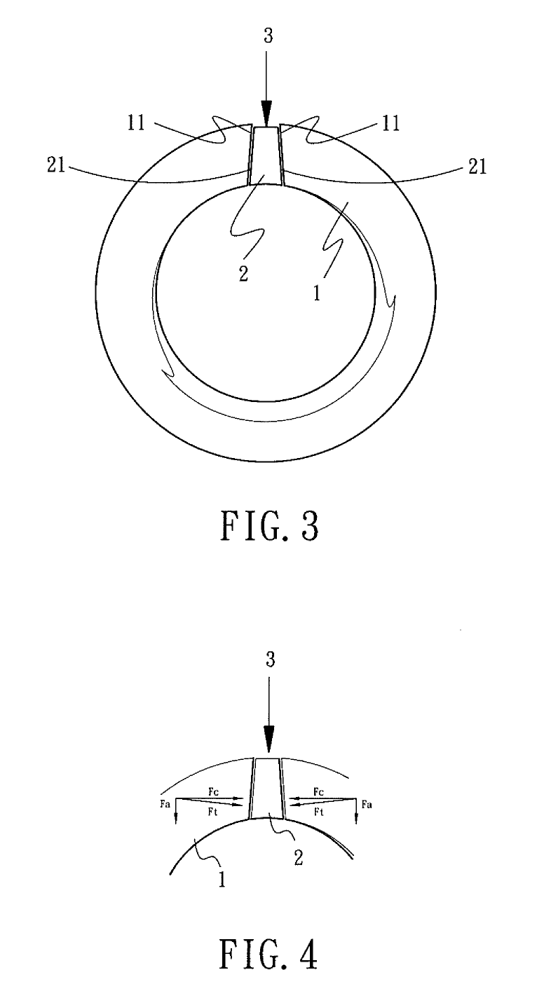

Referring to FIG. 3, a dust-proof structure for a ball screw in accordance with the present invention is shown and comprises: a wiper 1, a wiping piece 2 and a fastening device 5.

The wiper 1 is a C-shaped structure defined with a gap 3 for accommodation of the wiping piece 2. A bevel surface 11 is formed at either end of the wiper 1 and located at either side of the gap 3. The wiping piece 2 is also provided at either side thereof with a bevel surface 21 for mating with the bevel surfaces 11 of the gap 3, so that the wiper 1 and the wiping piece 2 come into contact with each other via the bevel surfaces.

Referring to FIG. 4, which is an illustrative view of showing the force analysis of the dust-proof structure for a ball screw in accordance with the present invention. Since the dust-proof structure uses the bevel surfaces to contact the wiper, when the external force to be applied is Fc, the resultant pushing force of the wiping piece 2 toward the screw shaft is only Fc*sin a. Furthermore, when the angle a is no greater than 10°, the resultant pushing force of the wiping piece 2 toward the screw shaft is only approximately 0.15 Fc. Therefore, the wiping piece 2 will abut against the surface of the screw shaft with a very light force, so that the degree to which the wiping piece 2 abuts against the surface of the screw shaft is controllable. Therefore, it not only has the dust proof effect, but also can prevent the occurrence of the excessively great friction.

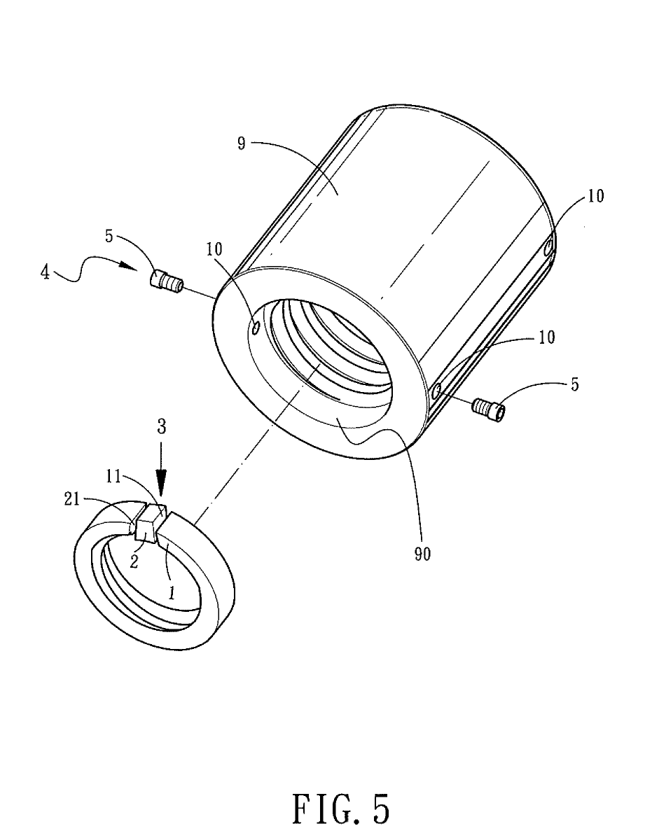

Please refer to FIG. 5 for a better understanding of the present invention. The wiper 1 is a C-shaped structure defined with the gap 3 for accommodation of the wiping piece 2. The wiper 1 together with the wiping piece 2 are inserted in the groove 91 of the nut 9, and then a bolt 5 is used to shrink the gap 3 by tightening the wiper 1 from both sides, so as to make the wiping piece 2 abut closely against the surface of the screw shaft, thus effectively solving the problem of dust invasion and high friction drag.

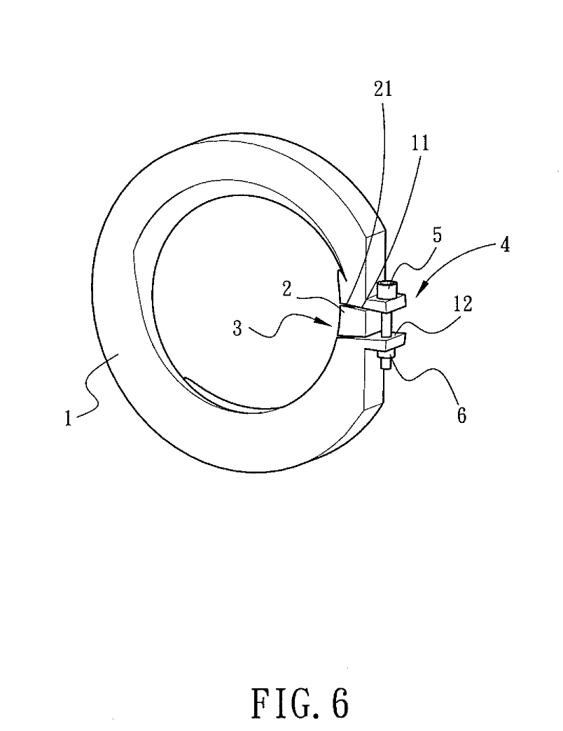

FIG. 6 shows a dust-proof structure for a ball screw in accordance with a second embodiment of the present invention, in which, a pair of protruding pieces 12 is formed at both abutting ends of the wiper 1 and located at both sides of the gap 3. A fastening device 4 is positioned on the protruding pieces 12 to shrink the gap 3 by applying a radial force to the wiper 1, thus making the wiping piece 2 abut closely against the surface of the screw shaft.

The interacting force between the bevel surfaces of the wiping piece 2 and the wiper 1 pushes the wiping piece 2 toward the surface of the screw shaft, thus effectively solving the problem of dust invasion and high friction drag.

The abovementioned interacting force and the radial force is produced by screwing the bolt 5 through the protruding pieces 12 into a nut 6.

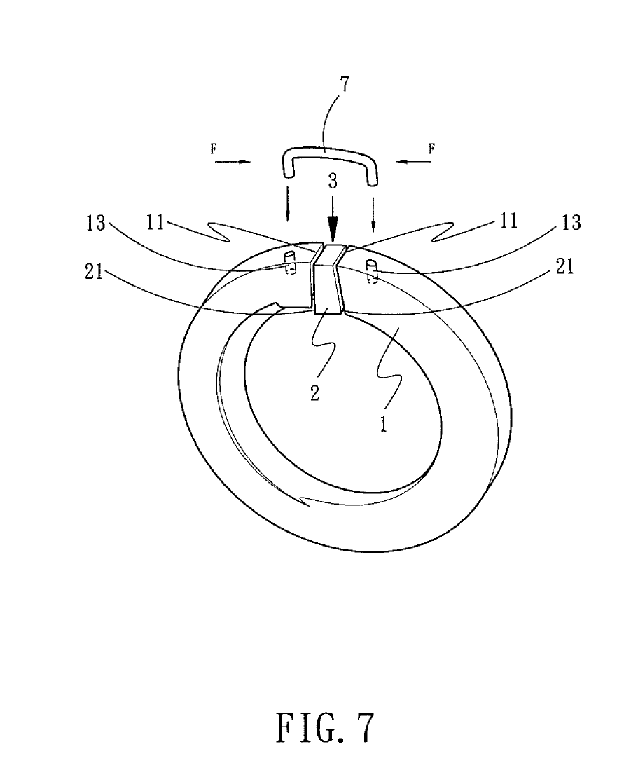

FIG. 7 shows a dust-proof structure for a ball screw in accordance with a third embodiment of the present invention. In addition to being tightened by the fastening device 4, the wiper 1 can also be closed by inserting an elastic piece 7 into the blind holes 13 formed in the surface of the wiper 1.

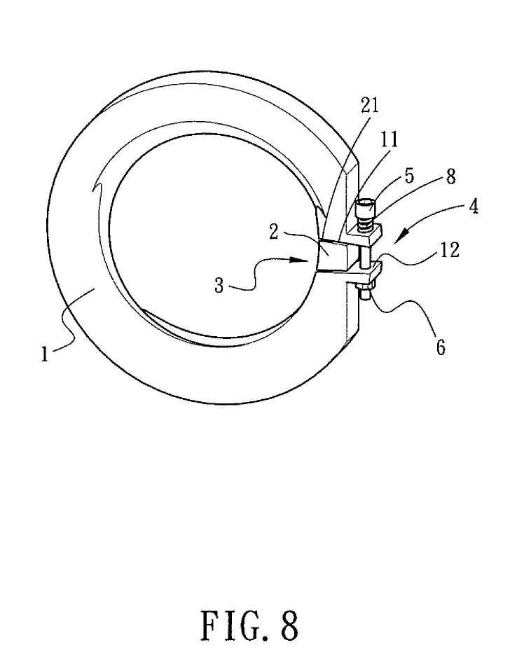

FIG. 8 shows a dust-proof structure for a ball screw in accordance with a fourth embodiment of the present invention, wherein the wiper 1 is tightened by screwing the bolt 5 through a spring 8 and the protruding pieces 12 and into a nut 6.

The user can make an adjustment progressively according to the wear of the wiping piece 2, and then fasten the wiper 1 by using the bolt 5 and the nut 6.

The adjustment should be made progressively because: the wiping piece 2 remains abutting closely against the surface of the bolt 5 for a certain period of time after installation, but as time goes by, the wear of the wiping piece 2 increases and the bolt 5 becomes loose, the wiping piece 2 will not be in contact with the surface of the screw shaft again. At this moment, the spring 8 on the bolt 5 can be used to adjust the wiping piece 2 and make it abut closely against the surface of the screw shaft again. The advantages of this design are that only the wiping piece 2 comes into contact with the surface of the screw shaft, on the other hand, the spring 8 allows the wiping piece 2 to keep abutting against the surface of the screw shaft, and the dust-proof function will not be affected by the wear of the wiping piece and the loose of the bolt 5.

To summarize, the dust-proof structure for a ball screw in accordance with the present invention is a C-shaped structure defined with a gap for accommodation of the wiping piece, and formed at either side of the gap is a bevel surface. The wiping piece is also formed at both sides thereof with a bevel surface for mating with the bevel surface of the gap, so that the wiper and the wiping piece are maintained into contact via the bevel surfaces. Moreover, a fastening device is provided at the outer edge of the gap to shrink the gap by applying a radial force to the wiper, thus making the wiping piece abut closely against the surface of the screw shaft.

Therefore, the interacting force between the bevel surfaces of the wiping piece and the wiper pushes the wiping piece toward the surface of the screw shaft, thus effectively solving the problem of dust invasion and high friction drag.

While we have shown and described various embodiments in accordance with the present invention, it is clear to those skilled in the art that further embodiments may be made without departing from the scope of the present invention.

What is claimed is:

1. A dust-proof structure for a ball screw comprising: a wiper, a wiping piece and a fastening device; characterized in that:
the wiper is a C-shaped structure defined with a gap for accommodation of a wiping piece and is annually mounted on a surface of a screw shaft, the wiper is formed at either side of the gap with a bevel surface, the wiping piece is also formed at both sides thereof with a bevel surface for mating with the bevel surface of the gap, so that the wiper and the wiping piece are maintained into contact via the bevel surfaces; and
the fastening device enables the C-shaped wiper to be deformed in radial direction, making the wiping piece abut against the surface of the screw shaft;
by such arrangements, an interacting force between the bevel surfaces of the wiping piece and the wiper pushes the wiping piece toward the surface of the screw shaft, thus effectively preventing dust.

2. The dust-proof structure for a ball screw as claimed in claim 1, wherein the gap of the wiper is formed in such a manner that its outer edge is smaller than its inner edge.

3. The dust-proof structure for a ball screw as claimed in claim 1, wherein the wiping piece is conical-shaped.

4. The dust-proof structure for a ball screw as claimed in claim 2, wherein the wiping piece is conical-shaped.

5. The dust-proof structure for a ball screw as claimed in claim 1, wherein the fastening device includes a blot to be screwed in a threaded hole and disposed at both ends of the wiper to tighten the wiper.

6. The dust-proof structure for a ball screw as claimed in claim 1, wherein a pair of protruding pieces is provided on an outer edge of the gap, and fastening device is screwed through protruding pieces into a nut.

7. The dust-proof structure for a ball screw as claimed in claim 1, wherein the fastening device cooperates with a spring engaged in gap.

8. The dust-proof structure for a ball screw as claimed in claim 1, wherein the fastening device includes a bolt to be screwed through a spring and protruding pieces and into a nut, and the fastening device is used to adjust the position of the wiping piece based on wear and tear of the wiping piece.

9. The dust-proof structure for a ball screw as claimed in claim 1, wherein the wiping piece is coated with a Teflon layer.
